(19) United States
(12) Patent Application Publication
(10) Pub. No.: US 2007/0122223 A1
(43) Pub. Date: May 31, 2007

(54) PRINTER

(75) Inventors: Kazutaka Suzuki, Fukushima-ken (JP); Hiroyuki Murayama, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/562,349

(22) Filed: Nov. 21, 2006

(30) Foreign Application Priority Data
Nov. 25, 2005 (JP) 2005-340639

(51) Int. Cl. B41J 2/315

(52) U.S. Cl. 400/120.02

(57) ABSTRACT

A printer includes a platen, a feed roller, recording units, a pressure auxiliary roller that faces an outer peripheral surface of the platen and is disposed at a front position before the recording units in a feed direction so as to press the recording medium against the outer peripheral surface of the platen, a pressure unit including pressure rollers that face the outer peripheral surface of the platen and is disposed at a back position after the pressure auxiliary roller in the feed direction so as to press the recording medium against the outer peripheral surface of the platen with a pressing force larger than a pressing force of the pressure auxiliary roller, and a control unit that causes a circumferential speed of the feed roller to be temporarily slower than a circumferential speed of the platen.

This application claims the benefit of priority to Japanese Patent Application No. 2005-340639, filed on Nov. 25, 2005, which is incorporated herein by reference.

### BACKGROUND OF THE INVENTION

1. Field of the Invention

The present invention relates to a printer, and particularly to a printer capable of being preferably used in a line thermal printer or an inkjet printer that prints on a recording medium, such as recording paper or the like, having a predetermined size, for example, a size of A4 or long roll paper with ink while pressing the recording medium against a roller-shaped platen.

2. Description of the Related Art

In general, a printer, such as a line thermal printer or an inkjet printer, applies or thermally transfers ink onto a recording medium, such as roll paper or recording paper, and may be used as an output device of a computer.

As shown in FIG. 8, for example, a printer 101 in the related art includes a roller-shaped platen 103, recording units 104, a feed roller 102, and a discharge roller 111. While applying tension to the recording medium 110 wound around the outer periphery of the platen, the roller-shaped platen 103 is rotated in the same direction as a feed direction FD of a recording medium 110. Each of the recording units 104 includes a thermal head or a recording head 104a, such as an ink nozzle. The feed roller 102 is disposed at a front position before the platen 103 in the feed direction FD so as to feed the recording medium 110, and the discharge roller 111 is disposed at a back position after the platen 103 in the feed direction FD so as to discharge the recording medium 110.

In this case, four recording units 104 are provided in a circumferential direction of the platen 103 so as to correspond to four colors, such as yellow, magenta, cyan, and black (or overcoat). Further, the recording medium 110 is interposed between the recording head 104a of each recording unit 104 and the platen 103. Accordingly, when the feed roller 102 and the discharge roller 111 are rotated, the recording medium 110 is wound around the outer peripheral surface of the platen 103 and fed in the predetermined feed direction FD. As a result, each of the recording units 104 records desired letters or images on the recording medium 110 (see, for example, JP-A-2003-251840).

However, the printer 101 in the related art does not include a unit for removing slack SS from the recording medium 110. Accordingly, as shown in FIG. 8, when the recording medium 110 does not come in close contact with the platen 103 and is fed with the slack SS, it is not possible to make the recording head 104a of each recording unit 104 appropriately come in contact with a portion of the recording medium 110 on which the slack SS occurs. As a result, it is not possible to record desired letters or images on the recording medium 110.

In addition, according to the printer 101 in the related art, until the recording medium 110 is fed to the discharge roller 111, the recording medium 110 cannot come in close contact with the outer peripheral surface of the platen 103, as a result, the recording units cannot begin recording on the recording medium 110.

### SUMMARY

An object of the invention is to provide a printer in which a recording medium can come in close contact with the surface of the platen.

Further, it is another object of the invention to provide a printer that does not perform unnecessary feeding of the recording medium and makes the recording medium come in close contact with the platen from the leading end of the recording medium.

Furthermore, it is another object of the invention to provide a printer in which each of the recording units can perform recording at a desired position on the recording medium even if the recording medium slides on the platen to remove slack from the recording medium.

In order to achieve the above-mentioned objects, according to a first aspect of the invention, a printer includes a feed roller that feeds a recording medium in a predetermined feed direction, a roller-shaped platen that is rotated in the feed direction of the recording medium, recording units that face an outer peripheral surface of the platen and approach or recede from the platen so as to record desired letters or images on the recording medium, a pressure auxiliary roller that faces the outer peripheral surface of the platen at a front position before the recording units in the feed direction and presses the recording medium against the outer peripheral surface of the platen, a pressure unit that includes pressure rollers, pushing means, and moving means, and a control unit that makes a circumferential speed of the feed roller become temporarily slower than a circumferential speed of the platen when the pressure rollers press the recording medium against the platen. In this case, each of the pressure rollers is formed in the shape of a roller that has a diameter smaller than a maximum distance between each of the recording units and the platen, and faces the outer peripheral surface of the platen at a back position after the pressure auxiliary roller in the feed direction. Further, when the recording medium is provided in a predetermined gap between each pressure roller and the platen, the pushing means pushes the pressure rollers against the outer peripheral surface of the platen with a pressing force larger than a pressing force of the pressure auxiliary roller. In addition, when the pressure rollers are pressed against the outer peripheral surface of the platen, the moving means moves the pressure rollers from front positions to the back positions in the feed direction of the recording medium in conjunction with the rotation of the platen.

According to the first aspect of the invention, the recording medium comes in close contact with the platen, and the platen and the feed roller for feeding the recording medium apply tension to the recording medium so as to remove the slack from the recording medium. As a result, it is possible to make the recording medium come in close contact with the platen.

According to a second aspect of the invention, in the printer according to the first aspect of the invention, the control unit may temporarily stop the platen and temporarily rotate the feed roller in a reverse direction.

According to the second aspect of the invention, since the recording medium is temporarily stopped to apply tension to the recording medium, it is possible to make the recording medium come in close contact with the platen from the leading end of the recording medium without over feeding the recording medium. Further, since the platen is stopped and the feed roller 2 is rotated in the reverse direction, it is possible to more quickly remove the slack from the recording medium as compared to when the feed roller and the platen are rotated in the same direction and the slack is removed by using a difference between the rotational speeds thereof.

According to a third aspect of the invention, in the printer according to the first or the second aspect of the invention, until each of the recording units begins to perform recording, the control unit may make the circumferential speed of the feed roller be slower than the circumferential speed of the platen. Further, after each of the recording units begins to perform the recording, the control unit may make the circumferential speed of the feed roller be equal to the circumferential speed of the platen.

According to the third aspect of the invention, after each of the recording units begins to perform the recording, the recording medium does not perform a sliding motion, which is performed to apply tension to the recording medium, on the outer peripheral surface of the platen. For this reason, the recording units can perform the recording at a desired position on the recording medium.

### BRIEF DESCRIPTION OF THE DRAWINGS

FIG. 1 is a front view of a printer according to an embodiment of the invention as seen in an axial direction of a platen;

FIG. 2 is a perspective view showing the printer of FIG. 1. Elements are mirror symmetric with respect to the platen, and only elements on one side of the platen in the axial direction of the platen are shown; and

FIG. 3 is a perspective view of a ring gear of FIG. 2;

FIGS. 4A and 4B are perspective views showing a roller unit of FIG. 2; FIG. 4A is a perspective view of the roller unit as seen from a front side of a base plate, and FIG. 4B is a perspective view of the roller unit as seen from a backside of the base plate;

FIG. 5 is a front view showing a platen, a first roller unit, a stationary cam disk, an actuator of the ring gear, and a first high pressure unit according to the embodiment of the invention, and is a front view schematically showing when a leading end of a recording medium is provided in a predetermined gap between the platen and a first pressure roller;

FIG. 6 is a front view of a detail of FIG. 1 schematically showing the platen, the first roller unit, the stationary cam disk, the actuator of the ring gear, and the first high pressure unit, showing that the first pressure roller is interposed between the first high pressure unit and the platen;

FIG. 7 is a schematic front view of a detail of FIG. 1; and

FIG. 8 is a front view of a printer in the related art.

### DETAILED DESCRIPTION

Reference will now be made in detail to embodiments. While the invention will be described in conjunction with these embodiments, it will be understood that it is not intended to limit the invention to such embodiments. In the following description, numerous specific details are set forth in order to provide a thorough understanding of the present invention which, however, may be practiced without some or all of these specific details. The same or equivalent elements or parts throughout the drawings are designated by the same reference characters.

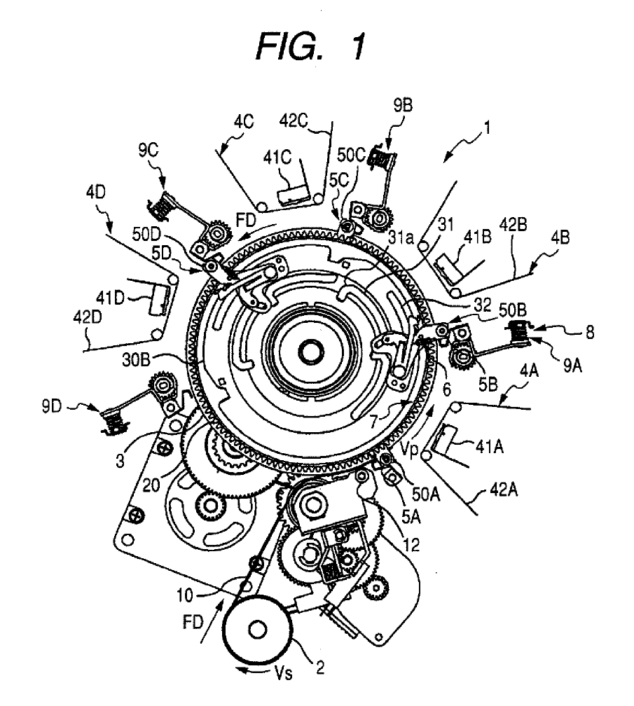

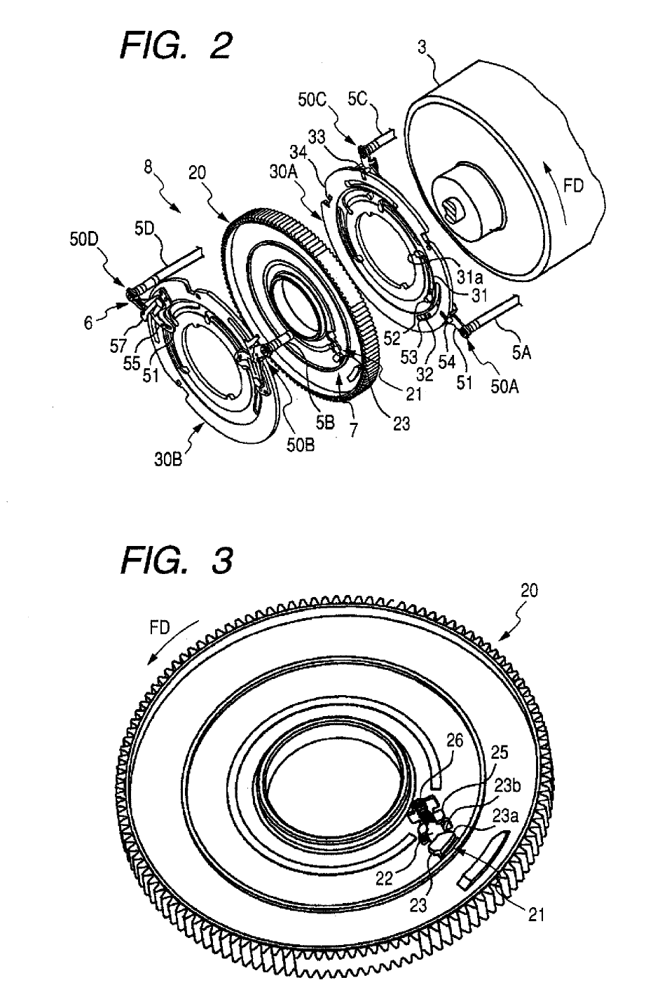

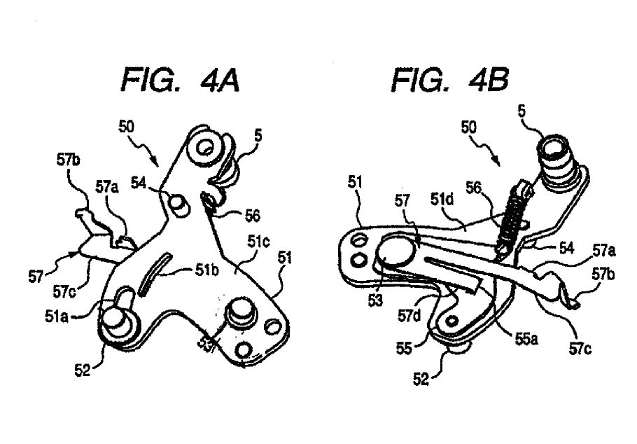

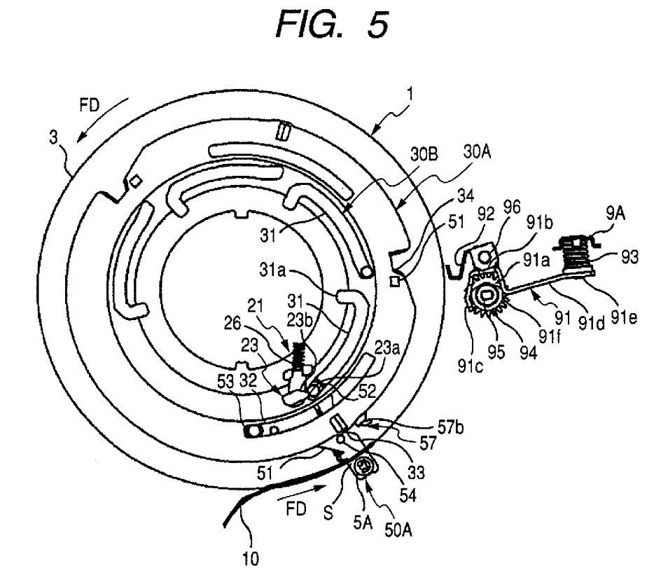

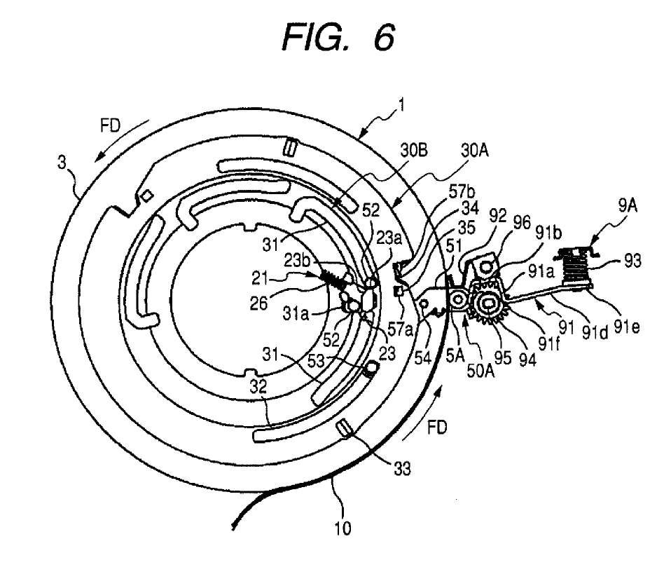

FIG. 1 is a front view of a printer, and FIG. 2 is a perspective view partially showing the printer. FIG. 3 is a perspective view of a ring gear. FIGS. 4A and 4B are perspective views showing a roller unit. FIGS. 5 and 6 are front views showing a platen, a first roller unit, a stationary cam disk, an actuator of the ring gear, and a first high pressure unit. FIG. 5 is a front view schematically showing when a leading end of a recording medium is provided in a predetermined gap between the platen and a first pressure roller. FIG. 6 is a front view schematically showing that the first pressure roller is interposed between the first high pressure unit and the platen. Since elements are mirror symmetric with respect to the platen, FIG. 2 shows only elements on one side of the platen in the axial direction of the platen.

As shown in FIG. 1, the printer 1 includes a feed roller 2, a roller-shaped platen 3, recording units 4(reference numerals 4A, 4B, 4C, and 4D of four recording units provided at four positions in the circumferential direction of the platen 3 are generalized by reference numeral 4), a pressure auxiliary roller 12, a pressure unit 8, and a control unit (not shown) in a case (not shown). The feed roller 2 feeds a recording medium 10, such as recording paper having a size of A4 or long roll paper, in a predetermined feed direction FD, and the platen 3 is rotated in the feed direction FD of the recording medium 10. The recording units 4 face the outer peripheral surface of the platen 3. The recording units 4 slide to approach or recede from the platen 3 in a radial direction of the platen 3, and record desired letters or images on the recording medium 10. The pressure auxiliary roller 12 faces the outer peripheral surface of the platen 3 at a front position before the recording units in the feed direction, and presses the recording medium 10 against the outer peripheral surface of the platen 3. The pressure unit 8 presses the recording medium 10 against the outer peripheral surface of the platen 3 by using pressure rollers 5 (reference numerals 5A, 5B, 5C, and 5D of four pressure rollers provided at four positions in the circumferential direction of the platen 3 are generalized by reference numeral 5 in this embodiment), and moves together with the platen 3. When the pressure rollers 5 press the recording medium 10 against the platen 3, the control unit controls a circumferential speed Vs of the feed roller 2 such that the circumferential speed Vs becomes temporarily slower than a circumferential speed Vp of the platen 3.

In addition, the pressure unit 8 includes the pressure rollers 5, pushing means 6, and moving means 7. Each of the pressure rollers 5 is formed in the shape of a roller that has a diameter smaller than a maximum distance between each recording unit 4 and the platen 3 and a length equal to or longer than an axial length of the platen 3. Further, the pressure rollers 5 face the outer peripheral surface of the platen 3 at positions after the pressure auxiliary roller 12 in the feed direction FD. When the recording medium 10 is provided in a predetermined gap between each pressure roller and the platen 3, the pushing means 6 pushes the pressure rollers 5 against the outer peripheral surface of the platen 3 with a pressing force F1 larger than a pressing force F2 of the pressure auxiliary roller 12. When the pressure rollers 5 are pressed against the outer peripheral surface of the platen 3, the moving means 7 moves the pressure rollers 5 from front positions to the back positions in the feed direction FD of the recording medium 10 in conjunction with the rotation of the platen 3.

Specifically, the feed roller 2 includes a cylindrical rod and a synthetic rubber, such as EPDM (ethylene propylene diene monomer) or the like, having a roller shape. The cylindrical rod is made of a material having high rigidity, such as metal or the like, and the synthetic rubber is attached on the side surfaces of the cylindrical rod. Further, the feed roller 2 is rotated in the same direction as the feed direction FD of the recording medium 10 by a rotational force from a stepper motor (not shown).

The platen 3 includes a cylindrical rod and a synthetic rubber, such as EPDM or the like, having a roller shape. The cylindrical rod is made of a material having high rigidity, such as metal or the like, and the synthetic rubber is attached on the side surfaces of the cylindrical rod. Further, the platen includes a mechanism that is rotated independently of the feed roller 2 in the same direction (counterclockwise direction in FIG. 1) as the feed direction FD of the recording medium 10 by a rotational force from a stepper motor (not shown). The diameter of the platen 3 is determined by consideration of the number of the recording units 4 and the size of the printer 1.

The recording units 4 include recording heads 41 (reference numerals 41A, 41B, 41C, and 41D are generalized by reference numeral 41) facing the outer peripheral surface of the platen 3, and are provided along the outer peripheral surface of the platen 3 so as to correspond to the number of colors to be printed, such as YMCK (yellow, magenta, cyan, and black), so that the colors are printed on the recording medium 10. Recording units, such as ink cartridge type or thermal head type recording units, may be used as the recording units 4. However, thermal head type recording units 4 may be used in this embodiment to improve printing quality. The thermal head type recording units 4 includes ink ribbons 42A, 42B, 42C, and 42D corresponding to the four colors of YMCK, and thermal heads (recording heads) 41A, 41B, 41C, and 41D that thermally transfer color ink onto the recording medium by using the ink ribbons. In addition, the four recording units 4 according to this embodiment are provided in the feed direction FD of the recording medium 10, and are referred to as a first recording unit 4A, a second recording unit 4B, a third recording unit 4C, and a fourth recording unit 4D from a front position to a back position in the feed direction FD.

The pressure auxiliary roller 12 includes a cylindrical rod and a synthetic rubber, such as EPDM or the like, having a roller shape. The cylindrical rod has a length equal to or longer than the axial length of the platen 3, and is made of a material having high rigidity, such as metal or the like. The synthetic rubber is attached on the side surfaces of the cylindrical rod. Further, the pressure auxiliary roller 12 includes a pressure mechanism. When it is determined that the recording medium 10 is interposed between the pressure auxiliary roller 12 and the platen 3 on the basis of a detection result from a detection sensor (not shown) that detects the recording medium 10 in the front vicinity of the pressure auxiliary roller 12 and a feed condition of the recording medium 10 obtained by the number of revolutions of the feed roller 2, the pressure mechanism pushes the pressure auxiliary roller 12 against the platen 3 toward the center of the platen 3 with a pressing force F2 by using pushing means (not shown), such as a coil spring or a hydraulic cylinder.

As described above, the pressure unit 8 includes the pressure rollers 5, and the pushing means 6, and the moving means 7. As shown in FIGS. 1 and 2, the pressure unit 8 includes two ring gears (only one ring gear is shown) 20 that are provided at both sides of the platen 3 in the axial direction of the platen 3, two pairs of stationary cam disks (only a pair of stationary cam disks is shown) 30 (reference numerals 30A and 30B are generalized by reference numeral 30) that are provided on the inner sides (both sides of the platen 3) and the outer sides of the ring gears 20 in the axial direction, and four roller units 50 (reference numerals 50A, 50B, 50C and 50D are generalized by reference numeral 50). In this case, two of the four roller units 50 are provided to each stationary cam disk 30. Further, each of the roller units 50, which has a pressure roller 5 and an elastic member 56, and stationary cam disks 30 that change pressing forces of the pressure rollers 5 are used as the pushing means 6 in the pressure unit 8 of this embodiment. Further, the ring gears 20 and the stationary cam disks 30 are used as the moving means 7. The ring gears 20 push the roller units 50, and the stationary cam disks 30 guide the roller units 50 in the circumferential direction while causing the roller units 50 to slide. Hereinafter, the components 20, 30, and 50 of the pressure unit 8 according to the embodiment will be described in detail.

As shown in FIGS. 1 to 3, each of the ring gears 20 is a spur gear that has a diameter of an addendum circle smaller than an outer diameter of the platen 3. An actuator 21, which rotates the pressure rollers 5 or members for supporting the pressure rollers 5 in the circumferential direction of the platen 3, is provided on each of the ring gears 20 inside a dedendum circle thereof.

The actuator 21 includes a sliding part 22 and a contact part 23. The sliding part 22 is formed in the shape of a rectangular flat plate, and the contact part 23 protrudes from an outer end of the sliding part 22 in the radial direction of the ring gear 20 toward the both sides (front and rear sides) of the sliding part 22 in a direction perpendicular to the sliding part 22. Further, the sliding part 22 of the actuator 21 is engaged with a sliding hole 25 having an engaging claw. The sliding hole 25 is formed through an inner portion of each ring gear 20 so as to be inclined in a direction (hereinafter, referred to as a “slide direction”) toward the clockwise direction by 30 to 60°. Further, the actuator 21 includes an elastic member 26, such as a coil spring, which pushes the contact part 23 toward the outside in the slide direction, at the other end of the sliding part 22.

In this example, the contact part 23 includes a circumferential pushing surface 23a and a radial pushing surface 23b. The circumferential pushing surface 23a is formed at the back end (left side in the counterclockwise direction) of the contact part 23 in the feed direction FD so as to be parallel to the radial direction of the ring gear 20. The radial pushing surface 23b is formed by chamfering the contact part 23 by 45° at the inner portion, which is disposed at the inner side as compared to the circumferential pushing surface 23a, of the contact part 23. When the contact part 23 is pushed toward the most outer portion of the ring gear in the slide direction by the elastic member 26, the circumferential pushing surface 23a of the contact part 23 comes in contact with lateral portions of movable guide posts 52 (to be described below) of the four roller units 50 that are mounted on the stationary cam disks 30 provided at both sides of each ring gear 20 and pushes the movable guide posts 52 in the rotation direction of the ring gear 20.

As shown in FIG. 2, each of the roller units 50 includes a pressure roller 5 provided to be parallel to a central axis of the platen 3, and two base plates (only one base plate is shown) 51 provided at both ends of each pressure roller 5 in the axial direction of the pressure roller.

Each of the pressure rollers 5 includes a cylindrical rod and a synthetic rubber, such as EPDM or the like, having a roller shape. The cylindrical rod is made of a material having high rigidity, such as metal or the like, and the synthetic rubber is attached on the side surfaces of the cylindrical rod. Further, since each of the pressure rollers 5 is provided at a back position after each of recording units 4 in the feed direction, the number of pressure rollers 5 is four in total. The recording rollers 5 according of this embodiment are provided in the feed direction FD of the recording medium 10, and are referred to as a first recording roller 5A, a second recording roller 5B, a third recording roller 5C, and a fourth recording roller 5D from a front position to a back position in the feed direction FD.

As shown in FIGS. 4A and 4B, each of the two base plates 51 is formed in a lateral T shape. Although being not shown, the two base plates 51 are provided at both ends of each pressure roller 5 so as to be mirror symmetric to each other. Further, the pressure roller 5 is rotatably supported by one of two ends facing each other among three ends of each base plate 51.

In addition, as shown in FIGS. 4A and 4B, each of the roller units 50 includes a movable guide post 52, a stationary guide post 53, a lift-up pin 54, a connection plate 55, an elastic member 56, and a stopper plate 57. The movable guide post 52 is provided at one end, which faces another end of the base plate supporting the pressure roller 5, of the base plate 51 on any one (this surface is not limited to a surface on which the pressure roller 5 is not provided) of the surfaces of the base plate 51. The stationary guide post 53 is fixed at the other end at which the pressure roller 5 and the movable guide post 52 are not provided, on the surface on which the movable guide post 52 is provided (hereinafter, the surface on which the movable guide post 52 is provided is referred to as a “front surface of the base plate”). The lift-up pin 54 is formed in a cylindrical shape, and is fixed on the front surface 51c of the base plate 51 between the pressure roller 5 and the movable guide post 52. A base portion of the connection plate 55 is rotatably supported by the stationary guide post 53 and the movable guide post 52 is fixed by the connection plate 55, so that both members 52 and 53 are connected to each other on the surface on which the movable guide post 52 is not provided (hereinafter, the surface on which the movable guide post 52 is not provided is referred to as a “back surface of the base plate”). The elastic member 56 pushes the connection plate 55 on the back surface 51d of the base plate 51 so that the movable guide post 52 approaches the lift-up pin 54. The stopper plate 57 includes a stopper part 57a and a stopper releasing part 57b, and is connected to the connection plate 55.

In this case, as shown in FIGS. 4A and 4B, the movable guide post 52 is formed in the shape of a pin having a flange, and is inserted into an elongated hole 51a formed through the base plate 51 in a direction in which the movable guide post 52 approaches or recedes from the pressure roller 5. That is, the movable guide post 52 is slidably moved about the stationary guide post 53 by the connection plate 55. Further, the movable guide post 52 is pushed toward the pressure roller 5 and the lift-up pin 54 by the connection plate 55 and the elastic member 56.

The stationary guide post 53 is formed in the shape of a pin having a flange, and is fixed on the back surface 51d of the base plate 51 so that the connection plate 55 and the stopper plate 57 are axially supported by the stationary guide post 53.

The connection plate 55 is formed of a thin metal sheet and formed substantially in a lateral L shape. At one end of the connection plate 55, the connection plate 55 rotates about the stationary guide post 53. In addition, the movable guide post 52 is provided at the other end of the connection plate 55, and one end of the elastic member 56 is fixed to the outside of the bend portion of the connection plate 55 that is formed in the lateral L shape.

An elastic member, which generates a pressing force F1 larger than a pressing force F2 of the pressure auxiliary roller 12, is used as the elastic member 56. A coil spring or the like may be used as the elastic member 56. One end of the elastic member 56 is fixed to a part of the connection plate 55 as described above, and the other end thereof is fixed on the back surface 51d of the base plate 51 in the vicinity of the pressure roller 5.

The stopper plate 57 is formed in the shape of a bifurcate thin plate that includes a long leg 57c and a short leg 57d. A base portion, at which the long leg 57c and the short leg 57d are connected to each other, of the stopper plate 57 is mounted on the back surface 51d of the base plate 51 at the back side of the connection plate 55, and is rotated about the stationary guide post 53. In this case, the long leg 57c includes a stopper releasing part 57b that is bent from the end of the long leg 57c toward the front surface 51c of the base plate 51, and a stopper part 57a that is bent from the vicinity of the stopper releasing part 57b toward the front surface 51c of the base plate 51 so as to have a length shorter than the stopper releasing part 57b. Further, the end of the short leg 57d is bent toward the front surface 51c of the base plate 51, and inserted into a mounting hole 55a of the connection plate 55 and a mounting groove 51b of the base plate 51. In this case, the mounting hole 55a of the connection plate 55 is formed in a rectangular shape, and the mounting groove 51b of the base plate 51 is formed to be oriented in a direction in which the short leg 57d does not prevent the slidable movement of the movable guide post 52.

Further, two roller units 50, which each include the pressure roller 5 on the back surface 51d of the base plate 51 as shown in FIGS. 4A and 4B, and two roller units 50 (not shown), which each include the pressure roller 5 on the front surface 51c of the base plate 51, are prepared in accordance with the positional relationship between the ring gears 20 and the stationary cam disks 30 (see FIG. 2). Elements of the roller units 50 are mirror symmetric with respect to the pressure roller 5 interposed therebetween so as to correspond to each other.

Further, as shown in FIG. 2, the roller units 50 including the pressure roller 5 on the back surface 51d of the base plate 51 are first provided to the stationary cam disks 30A and 3DB, and the four roller units 50 are alternately provided to the stationary cam disks 30A and 30B from the front positions to the back positions in the feed direction FD of the recording medium 10. In this case, the four roller units 50 provided to the stationary cam disks are referred to as a first roller unit 50A, a second roller unit 50B, a third roller unit 50C, and a fourth roller unit 50D from the front positions to the back positions in the feed direction ED of the recording medium 10. As shown in FIG. 2, the first roller unit 50A and the third roller unit 50C (the roller units 50 including the pressure roller 5 on the back surface 51d of the base plate 51) are mounted on one pair of stationary cam disks 30A that are provided on the inner sides (both sides of the platen 3) of the ring gears 20 in the axial direction. Further, the second roller unit 50B and the fourth roller unit 50D (the roller units 50 including the pressure roller 5 on the front surface 51 c of the base plate 51) are mounted on the other pair of stationary cam disks 30B that are provided on the outer sides of the ring gears 20 in the axial direction.

As shown in FIGS. 5 and 6, each of the stationary cam disks 30 provided with the roller units 50 is formed in a disk shape and has a diameter smaller than a distance that is obtained by subtracting a distance between the central axis of the pressure roller 5 and the central axis of the lift-up pin 54 from the radius of the platen 3. Each of the stationary cam disks 30 is concentric with the platen 3, and is fixed not to rotate together with the platen 3 or the roller units 50. In addition, each of the stationary cam disks 30 includes movable guide post guiding holes 31, stationary guide post guiding holes 32, lift cams 33, stopper releasing holes 34, and stopper holes 35. Each of the movable guide posts 52 is inserted into each of the movable guide post guiding holes 31, and each of the stationary guide posts 53 is inserted into each of the stationary guide post guiding holes 32. The lift cams 33 push the lift-up pins 54 toward the outside in the radial direction of the stationary cam disk 30. The stopper releasing holes 34 are formed on the peripheral surface of each stationary cam disk 30, and the stopper holes 35 are formed on each stationary cam disk 30 so as to be close to the stopper releasing holes 34, respectively.

Each of the movable guide post guiding holes 31 has a radius obtained by subtracting a distance, which is larger than a minimum distance between the lift-up pin 54 and the movable guide post 52 and smaller than a maximum distance therebetween, from the radius of the stationary cam disk 30. Each of the movable guide post guiding holes 31 is formed of an arc-shaped through hole that has the same center as the stationary cam disk 30. A curved portion 31a oriented toward the center of the stationary cam disk 30 is formed at the end (left end of the arc shown in FIG. 2) of each movable guide post guiding hole 31 in the rotation direction.

Further, each of the stationary guide post guiding holes 32 is formed in the shape of an arc that has the same center as the arc-shaped movable guide post guiding holes 31. The stationary guide post guiding holes 32 are formed in the stationary cam disks 30 so that the stationary guide posts 53 are inserted into the stationary guide post guiding holes 32 when the movable guide post 52 is inserted into the movable guide post guiding holes 31 and the lift-up pin 54 comes in contact with the peripheral surface of the stationary cam disk 30.

Each of the lift cams 33 is formed in a convex shape on the stationary cam disks 30 so as to push the lift-up pins 54 toward the outside in the radial direction of the stationary cam disk 30 when the movable guide post 52 and the stationary guide post 53 of each roller unit 50 are positioned at the front positions (the most right sides) of the movable guide post guiding holes 31 and the stationary guide post guiding holes 32, respectively. Further, each of the lift cams 33 has a lift distance such that a distance obtained by adding a distance between the center of the stationary cam disk 30 and the top of the lift cam 33 and a distance between the central axis of the pressure roller 5 and the central axis of the lift-up pin 54 is larger than the radius of the platen 3.

Each of the stopper releasing holes 34 is cut and formed in the stationary cam disks 30 so that the lift-up pins 54 and the stopper releasing parts 57b positioned near the peripheral surfaces of the stationary cam disks 30 are fitted into the stopper releasing holes 34 in the radial direction of the stationary cam disks 30 when the movable guide post 52 and the stationary guide post 53 of each roller unit 50 are positioned at the back positions (the most left sides) of the movable guide post guiding holes 31 and the stationary guide post guiding holes 32, respectively (see FIG. 6).

Each of the stopper holes 35 is sized to contain the stopper part 57a of the stopper plate 57 therein, and is formed in a rectangular shape. When each of the lift-up pins 54 is moved to the inner portion in the radial direction due to the stopper releasing hole 34, the stopper part 57a of the stopper plate 57 is engaged with the stopper hole 35.

Further, the positions of the movable guide post guiding holes 31, the stationary guide post guiding holes 32, the lift cams 33, the stopper releasing holes 34, and the stopper holes 35 are different depending on each pair of stationary cam disks 30. The positions of the movable guide post guiding holes 31, the stationary guide post guiding holes 32, the lift cams 33, the stopper releasing holes 34, and the stopper holes 35 are determined by one pair of stationary cam disks 30A in accordance with the mounting positions of the first roller unit 50A and the third roller unit 50C. Further, the positions of the movable guide post guiding holes 31, the stationary guide post guiding holes 32, the lift cams 33, the stopper releasing holes 34, and the stopper holes 35 are determined by the other pair of stationary cam disks 308 in accordance with the mounting positions of the second roller unit 50B and the fourth roller unit 50D.

As shown in FIG. 1, the pressure unit 8 may include four high pressure units 9 (reference numerals 9A, 9B, 9C and 9D are generalized by reference numeral 9). As shown in FIG. 5, each of the high pressure units 9 includes a high pressure plate 91, a base plate restraining plate 92, a high pressure elastic member 93, and a cam 94 for high pressure plate.

Specifically, the high pressure plate 91 is formed of a metal sheet that has a length longer than the axial length of the platen 3 and a width smaller than the axial length of the pressure roller 5, so as to have a ladle-shaped cross section in the radial direction of the platen 3. A portion of the high pressure plate 91 corresponding to a bottom 91b of a receiving part 91a in the ladle-shaped cross section is rotatably supported by a rotating shaft 96 provided parallel to the axial direction of the platen 3. The high pressure plate 91 is provided so that a portion (a portion opposite to the high pressure elastic member 93) of the high pressure plate 91 corresponding to the end 91c of the receiving part 91a in the ladle-shaped cross section is separated from the outer peripheral surface of the platen 3 by a distance larger than the diameter of the pressure roller 5 when the high pressure plate 91 is rotated about the rotating shaft 96 in the counterclockwise direction. Further, the high pressure plate 91 is provided so that the portion of the high pressure plate 91 corresponding to the end 91c of the receiving part 91a in the ladle-shaped cross section is separated from the outer peripheral surface of the platen 3 by a distance smaller than the diameter of the pressure roller 5 when the high pressure plate 91 is rotated about the rotating shaft 96 in the clockwise direction.

The base plate restraining plate 92 is formed of a metal sheet that has a width longer than the axial length of the platen 3, so as to have a ladle-shaped cross section in the radial direction of the platen smaller than that of the high pressure plate 91. The base plate restraining plate 92 is provided so that the base plate restraining plate 92 comes in contact with only the base plate 51 and prevents the movement of the roller unit 50 when the roller unit 50 is moved in conjunction with the rotation of the platen 3.

The high pressure elastic member 93 is formed to have an elastic force larger than the elastic member 56 of the roller unit 50. The high pressure elastic member 93 is provided so that an elastic force is generated from a portion of the high pressure plate 91 corresponding to an end 91e of a handle 91d of the ladle-shaped cross section so as to rotate the high pressure plate 91 in the clockwise direction.

The cam 94 for a high pressure plate is formed on a cam shaft 95 having a gear that is connected to a step motor (not shown). The cam 94 for high pressure plate is provided so that a portion of the high pressure plate 91 corresponding to a connection portion 91f between the receiving part 91a and the handle 91d at a position corresponding to the inside of the receiving part 91a in the ladle-shaped cross section is pressed due to the rotation of the cam 94 for the high pressure plate and the high pressure plate 91 is rotated in the counterclockwise direction. The control unit for controlling the movement of the recording units 4 controls the rotation of the cam 94 for the high pressure plate.

Since each of the high pressure units 9 is provided at the back position after each of the recording units 4, the high pressure units 9 are referred to as a first high pressure unit 9A, a second high pressure unit 9B, a third high pressure unit 9C, and a fourth high pressure unit 9D from a front position to a back position in the feed direction FD of the recording medium 10.

Further, as shown in FIG. 1, the control unit of the printer 1 independently controls the circumferential speed Vs of the feed roller 2, the circumferential speed Vp of the platen 3, the moving speeds of the pressure rollers 5, and the positions to which the recording units 4 are slidably moved. Accordingly, the control unit is formed of a circuit that receives information from the step motor for rotating the ring gears 20 or the step motor for rotating the feed roller 2 and outputs control signals to the recording units 4 or the cams 94 for the high pressure plate. Specifically, the control unit is formed of a control circuit formed using a storage unit, such as a memory, and a processing device, such as a CPU.

In addition, it is preferable that the control unit temporarily stop the platen 3 and temporarily rotate the feed roller 2 in a reverse direction. In this case, when the control unit controls the platen and the feed roller as described above, the control unit may strongly press the pressure rollers 5 against the platen 3 by using the high pressure units 9 and then temporarily stop the platen 3.

Until each of the recording units 4 provided at the front position before each of the pressure rollers 5 in the feed direction FD begins to perform the recording on the recording medium 10, the control unit according to this embodiment may preferably perform the control in which the circumferential speed Vs of the feed roller 2 becomes slower than the circumferential speed Vp of the platen 3. Further, after each of the recording units 4 begins to perform the recording, the control unit according to this embodiment may perform the control in which the circumferential speed Vs of the feed roller 2 becomes equal to the circumferential speed Vp of the platen 3.

In addition, the printer 1 may include a calculating device (not shown) and a pressure unit controlling device (not shown). The calculating device calculates that the leading end of the recording medium 10 is provided in a predetermined gap 5 between each of the pressure rollers 5 and the platen 3, on the basis of the detection result from the detection sensor (not shown) for detecting the recording medium 10 in the front vicinity of the pressure auxiliary roller 12 and the feed condition of the recording medium 10 obtained by the number of revolutions of the feed roller 2. The pressure unit controlling device controls the moving means 7 of the pressure unit 8 on the basis of the calculation results.

A sensor that reacts to the characteristics of the recording medium 10 other than the color or material of the recording medium 10 may be used as the detection sensor. Further, a CPU (Central Processing Unit), which performs a calculation process on the basis of the detection results from the detection sensor and the number of steps of the step motor for the feed roller 2, or a circuit that is formed using other processing devices may be used as the calculating device.

Furthermore, the pressure unit controlling device may be formed of a circuit that outputs control signals to the moving means 7. The pressure unit controlling device may be formed of a circuit formed using a storage unit, such as a memory, or a processing device, such as a CPU.

The calculating device and the pressure unit controlling device may also be formed to serve as the above-mentioned control unit.

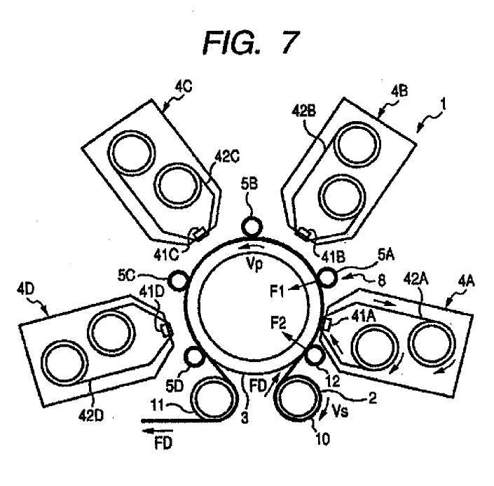

The operations of the printer 1 according to this embodiment will be described with reference to FIGS. 1 to 7. FIG. 7 schematically shows the operations of the printer.

As shown in FIG. 1, according to the printer 1 of this embodiment, the recording medium 10 is pressed against the outer peripheral surface of the platen 3 by the pressure rollers 5 and the pressure auxiliary roller 12 of the pressure unit 8 that faces the outer peripheral surface of the platen 3. When the recording medium 10 begins to be fed due to the rotation of the feed roller 2, the recording medium 10 passing between the pressure auxiliary roller 12 and the platen 3 is pressed against the platen 3 and the leading end of the recording medium 10 enters the predetermined gap 5 between the pressure rollers 5 and the platen 3. When the calculating device calculates that the leading end of the recording medium 10 is provided in the predetermined gap 5, the ring gear 20 is rotated at a speed equal to the circumferential speed of the platen 3 and the contact part 23 of the actuator 21 of the ring gear 20 pushes the movable guide post 52 of the first roller unit 50A in the rotation direction of the platen 3 as shown in FIG. 5. Since the stationary cam disk 30 on which the first roller unit 50A is mounted is rotated, the lift-up pin 54 is moved down from the lift cam 33 of the stationary cam disk 30 onto the outer periphery of the stationary cam disk 30 and moved inward in the radial direction of the stationary cam disk 30 due to the tension of the elastic member 56 of the roller unit 50. Accordingly, the pressure rollers 5 press the leading end of the recording medium 10 against the outer peripheral surface of the platen 3. In addition, the movable guide post 52 pushed by the actuator 21 is moved along the movable guide post guiding hole 31 in conjunction with the rotation of the platen 3. That is, as shown in FIGS. 1 and 5, the pressure auxiliary roller 12 and the pressure rollers 5 press the recording medium 10 against the platen 3, and the pressure rollers 5 are moved toward the back position in the feed direction in conjunction with the rotation of the platen 3 while pressing the recording medium 10 against the platen 3.

Further, as shown in FIG. 7 the circumferential speed Vs of the feed roller 2 is controlled to be temporarily slower than the circumferential speed Vp of the platen 3. In this case, when the circumferential speed Vs of the feed roller 2 is slower than the circumferential speed Vp of the platen 3, the speed of the recording medium 10 fed by the platen 3 is relatively faster than the speed of the recording medium 10 fed by the feed roller 2. In addition, the pressing force F2 of the pressure auxiliary roller 12 is smaller than the pressing force F1 of each pressure roller 5. Accordingly, while being interposed between the platen 3 and the first pressure roller 5A, the recording medium 10, which is pressed against the platen 3 by the pressure auxiliary roller 12 and the first pressure roller 5A, is stretched by the platen 3 and the first pressure roller 5A. As a result, tension is applied to the recording medium 10 by the feed roller 2 and the pressure rollers 5.

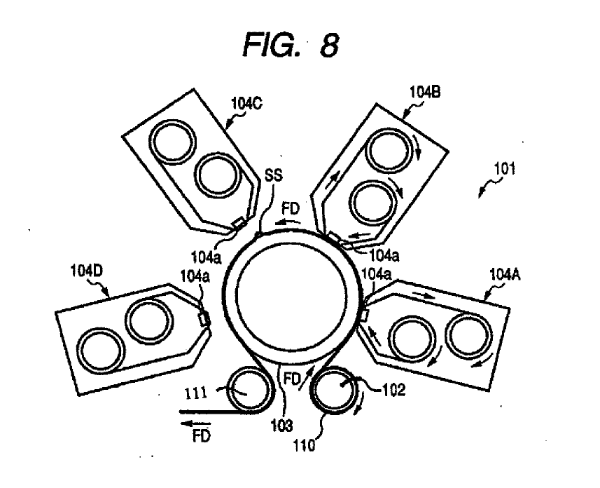

Since the tension is applied to the recording medium 10 to remove the slack SS (see FIG. 8) of the recording medium 10, the recording medium 10 can come in close contact with the surface of the platen 3. As shown in FIG. 7, the pressure roller 5 passes by the lower portion of the first recording unit 4A. Accordingly, even though the recording medium 10 has not been yet fed to a discharge roller (not shown) provided at a back position after the platen 3 in the feed direction FD, the first recording unit 4A slidably approaches the platen 3 to begin to perform the recording on the recording medium 10 (hereinafter, “the slidable approach of the first recording unit 4A to the platen 3” is referred to as “the head down” of the first recording unit 4A”).

The calculating device of the printer 1 can calculate the correct position of the leading end of the recording medium 10, which is detected by the detection sensor, on the feed path. Accordingly, the pressure unit controlling device can make the pressure rollers 5 come in close contact with the leading end of the recording medium 10. For this reason, since the tension is applied to the recording medium 10 from the leading end thereof, the first recording unit 4A can begin to perform the recording on the recording medium 10 without forming an unnecessary margin in the vicinity of the leading end of the recording medium 10. Therefore, while being pressed against the platen 3, the leading end of the recording medium 10 is fed to the back position in the feed direction in conjunction with the rotation of the platen 3. As a result, it is possible to prevent the leading end of the recording medium 10 from returning while being bumped against the recording units 4, and to easily control the feed direction FD of the recording medium 10.

Further, as shown in FIG. 6, when the pressure rollers 5 press the recording medium 10 against the platen 3 by the actuator 21 of the ring gear 20 and are moved in conjunction with the rotation of the platen 3, the high pressure plates 91 of the high pressure units 9 press the pressure rollers 5 against the platen 3.

Specifically, as shown in FIG. 6, the base plate 61 of the first roller unit 50A comes in contact with the base plate restraining plate 92 of the first high pressure unit 9A, thereby preventing the movement of the first roller unit 5CA. In this case, the movable guide post 52 pushed in the circumferential direction by the contact part 23 of the actuator 21 reaches the curved portion 31a of the movable guide post guiding hole 31 formed in the stationary cam disk 30. Accordingly, the movable guide post 52 is moved to the inner portion in the radial direction along the movable guide post guiding hole 31, and is pushed to the inner portion in the radial direction by the radial pushing surface 23b of the contact part 23. As a result, the movable guide post 52 is separated from the contact part 23 along the circumferential pushing surface 23a and the radial pushing surface 23b in this order, so that the force that moves the pressure roller 5 of the first roller unit 50A in conjunction with the rotation of the platen 3 is removed.

In addition, when the movable guide post 52 is pushed to the inner portion in the radial direction, the stopper part 57a of the stopper plate 57 that is interlocked with the connection plate 55 provided to the movable guide post 52 is moved to the inner portion in the radial direction. Further, the stopper part 57a is engaged with the stopper hole 35 of the stationary cam disk 30. For this reason, the movable guide post 52 is separated from the contact part 23 of the actuator 21. The stopper part 57a and the stopper hole 35 are engaged with each other and the movable guide post 52 is not moved due to the curved portion 31a of the guide hole 31. As a result, even though the elastic member 56 of the first roller unit 50A pulls the movable guide post 52 to the outside in the radial direction, the first roller unit 50A is positioned.

When the first recording unit 4A begins to perform the head down operation on the basis of the feed distance of the recording medium 10, the cam 94 for the high pressure plate of the first high pressure unit 9A is rotated so as to reduce the lift distance thereof and the high pressure elastic member 93 pushes the high pressure plate 91 so that the high pressure plate 91 is rotated about the rotating shaft 96 in the clockwise direction.

That is, since the first high pressure unit 9A operates to apply a high pressing force, which pushes the pressure roller 5 against the platen 3, to the pressure roller 5, the recording medium 10 interposed between the pressure roller 5 and the platen 3 is strongly pressed against the platen 3. As a result, even though the first recording unit 4A comes in contact with the recording medium 10 so as to perform the recording, the first recording unit 4A can perform the recording on the recording medium 10.

Even after the first high pressure unit 9A applies the high pressing force to the pressure roller 5, the pressure roller 5 is driven to rotate due to the rotation of the platen 3 while applying the high pressing force to the recording medium 10. For this reason, the printer 1 can feed the recording medium 10 in the predetermined feed direction FD.

When a pressing force, which is larger than the pressing force F1 applied to the pressure roller 5 by the high pressure unit 9A, is applied to the recording medium 10, the control unit may temporarily stop the platen 3 and temporarily rotate the feed roller 2 in a reverse direction. For this reason, even though the recording medium 10 is not fed, tension is applied to the recording medium 10. As a result, even though the recording medium 10 is over fed to remove the slack SS, it is possible to make the recording medium 10 come in close contact with the platen 3. Further, when the platen 3 is stopped and the feed roller is rotated in the reverse direction, it is possible to quickly and easily remove the slack SS as compared to when the feed roller 2 and the platen 3 are rotated in the same direction and the slack SS is removed by using a difference between the rotational speeds thereof. However, when the feed roller 2 is rotated in the reverse direction and the leading end of the recording medium 10 does not slide and is interposed between the platen 3 and the pressure roller 5 due to the pressing force F1 applied to the platen 3 by the pressure roller 5, the platen 3 may be temporarily stopped and the feed roller 2 may be temporarily rotated in the reverse direction before the high pressure unit 9 strongly presses the pressure roller 5 against the platen 3.

In some cases, while the recoding medium 10 slides on the outer peripheral surface of the platen 3, the above-mentioned operations may be performed to remove the slack SS. For this reason, when the recording medium 10 slides on the outer peripheral surface of the platen, the recording units 4 may not correctly record desired letters or images on the recording medium 10. Accordingly, until each of the recording units 4 provided at the front position before each of the pressure rollers 5 in the feed direction FD begins to perform the recording on the recording medium 10, the control unit may perform the control in which the circumferential speed Vs of the feed roller 2 becomes slower than the circumferential speed Vp of the platen 3. Further, after each of the recording units 4 begins to perform the recording, the control unit may perform the control in which the circumferential speed Vs of the feed roller 2 becomes equal to the circumferential speed Vp of the platen 3. For this reason, after each of the recording units 4 begins to perform the recording, the recording medium 10 does not slide on the outer peripheral surface of the platen 3. As a result, it is possible to perform the recording at desired positions on the recording medium 10.

In addition, the roller units 50 and the high pressure units 9 are provided in the printer 1 so as to correspond to the number of the recording units 4. Accordingly, after the first roller unit 50A strongly presses the recording medium against the platen, it is possible to sequentially perform the pressing operations in which the first recording unit 4A begins to perform the recording and the second roller unit 50B then presses the recording medium 10 against the platen and is moved during the recording performed by the first recording unit 4A.

As shown in FIG. 6, when the movable guide post 52 of the first roller unit 50A is separated from the contact part 23 of the actuator 21 and the stopper part 57a is engaged with the stopper hole 35 of the stationary cam disk 30, the actuator 21 is positioned so as to push the movable guide post 52 of the second roller unit 50B in the circumferential direction.

In this case, as shown in FIG. 2, since the first roller unit 50A and the second roller unit 50B are provided to different stationary cam disks 30, the movable guide post 52 of the second roller unit 50B protrudes from the base plate 51 in a direction different from a direction in which the movable guide post 52 of the first roller unit 50A protrudes from the base plate 51. However, as shown in FIG. 2, since the movable guide post 52 of the first roller unit 50A and the movable guide post 52 of the second roller unit 50B are provided to face the ring gear 20, the contact part 23 of the actuator 21 protrudes toward both sides of the ring gear 20 in the axial direction of the ring gear 20. Accordingly, as shown in FIG. 6, the actuator 21 pushes the movable guide post 52 of the second roller unit 50B next to the positioned first roller unit 50A and moves down the lift-up pin 54, so that the second pressure roller 50B can press the leading end of the recording medium 10 against the platen 3. Since this is the same as in the relationship between the second roller unit 50B and the third roller unit 50C and in the relationship between the third roller unit 50C and the fourth roller unit 50D, it is possible to apply the correct pressing force to the recording medium 10 so as to correspond to each of the recording units 4.

That is, even though the feed path between the feed roller 2 and the discharge roller 11 is increased due to the increase in the number of recording units 4 to be provided and the diameter of the platen 3, the plurality of pressure rollers 5A, 5B, 5C, and 5D strongly press the recording medium 10 against the platen at positions corresponding to the recording units 4. For this reason, even though the recording units 4, which come in contact with the recording medium 10 to perform the recording thereon, apply impact to the recording medium 10 several times, it is possible to prevent the desired letters or images from being incorrectly recorded on the recording medium 10 due to misalignment of the recording medium 10 with the platen 3.

The pressure rollers sequentially press the recording medium 10 from the first pressure roller 5A to correctly apply the pressing force, which is necessary to perform the recording, to the recording medium 10. Accordingly, unlike a printer 101 in the related art, even though the leading end of the recording medium 10 has not been yet fed to a discharge roller provided at a back position after the platen 3 in the feed direction, the recording units can sequentially record desired letters or images on the recording medium 10 from the first recording unit 4A.

That is, even though the slack occurs on the recording medium, it is possible to make the recording medium preferably come in close contact with the platen until the recording units begin to perform the recording. Therefore, it is possible to improve the recording quality of the printer.

Further, it is possible to make the recording medium come in close contact with the platen from the leading end of the recording medium. Accordingly, it is possible to perform the recording on the recording medium from the leading end thereof without forming the unnecessary margin, on which the recording cannot be performed, on the recording medium.

Even though slack occurs on the recording medium, it is possible to make the recording medium come in close contact with the platen until the recording units begin to perform the recording. Therefore, it is possible to improve the recording quality of the printer.

Further, it is possible to make the recording medium come in close contact with the platen from the leading end of the recording medium. Accordingly, it is possible to perform the recording on the recording medium from the leading end thereof without forming the unnecessary margin, on which the recording cannot be performed, on the recording medium.

Although only a few examples of this invention have been described in detail above, those skilled in the art will readily appreciate that many modifications are possible thereto without materially departing from the novel teachings and advantages of the invention. Accordingly, all such modifications are intended to be included within the scope of this invention as defined in the following claims.

What is claimed is:

1. A printer comprising:
a feed roller that feeds a recording medium in a predetermined feed direction;
a roller-shaped platen that is rotated in the feed direction of the recording medium;
recording units that face an outer peripheral surface of the platen and approach or recede from the platen so as to record desired letters or images on the recording medium;
a pressure auxiliary roller that faces the outer peripheral surface of the platen at a front position before the recording units in the feed direction and presses the recording medium against the outer peripheral surface of the platen;
a pressure unit that includes pressure rollers, means for pushing, and means for moving; and
a control unit that causes a circumferential speed of the feed roller to be temporarily slower than a circumferential speed of the platen, when the pressure rollers press the recording medium against the platen,
wherein each of the pressure rollers is formed in the shape of a roller that has a diameter smaller than a maximum distance between each of the recording units and the platen, and faces the outer peripheral surface of the platen at a back position after the pressure auxiliary roller in the feed direction, such that when the recording medium is provided in a predetermined gap between the pressure roller and the platen, the means for pushing pushes the pressure rollers against the cuter peripheral surface of the platen with a pressing force larger than a pressing force of the pressure auxiliary roller, and the means for moving moves the pressure rollers from front positions to the back positions in the feed direction of the recording medium in conjunction with the rotation of the platen.

2. The printer according to claim 1, wherein the control unit temporarily stops the platen and temporarily rotates the feed roller in a reverse direction.

3. The printer according to claim 1, wherein until each of the recording units begins to perform recording, the control unit causes the circumferential speed of the feed roller to be slower than the circumferential speed of the platen, and after each of the recording units begins to perform the recording, the control unit causes the circumferential speed of the feed roller to be equal to the circumferential speed of the platen.
